(19) United States
(12) Patent Application Publication
(10) Pub. No.: US 2006/0132832 A1
(43) Pub. Date: Jun. 22, 2006

(54) Automated telephone number transfer

(75) Inventors: Sonia Lippe, West End (AU); Dominic Yow-Sin Cheung, Heidelberg (DE)

Correspondence Address: SCHWEGMAN, LUNDBERG, WOESSNER & KLUTH, P.A., P.O. BOX 2938, MINNEAPOLIS, MN, 55402, US

(73) Assignee: SAP Aktiengesellschaft

(21) Appl. No.: 11/015,829

(22) Filed: Dec. 17, 2004

(51) Int. Cl. G06F 3/12

(52) U.S. Cl. 358/1.15

(57) ABSTRACT

A method and a system allow a user of a portable communication device such as a mobile telephone to transfer contact data automatically from the portable communication device to a fixed line communication device and initiate a call to a selected contact via the fixed line device. The portable device transmits contact data wirelessly to a wireless reception unit associated with the fixed line communication device, and carries out a permission process to ensure that the portable device is authorized to instruct the fixed line device to initiate a call. The portable device then instructs the fixed line device to initiate a call and the user uses an audio interface of the fixed line device to make the call.

### FIELD OF THE INVENTION

The present application relates generally to the technical field of telecommunications and, in one specific example, to a method, system and apparatus to facilitate the making of telephone calls.

### BACKGROUND OF THE INVENTION

As mobile devices such as mobile telephones and PDAs become increasingly popular, many persons maintain a list of contacts in a mobile device. The data defining each contact may include a telephone number, e-mail address or other data. When making a call to a contact using the mobile device, a user simply selects a desired contact from a list of stored contacts and initiates a call directly from the mobile device.

For various reasons, it may be preferable to make a call from a communication device other than the mobile device on which a user's contacts are stored. For example, a user may prefer to make calls from a desk telephone in his or her office for reasons of cost, audio quality or call billing purposes. In this case, the user will typically have to look up a contact in the mobile device and manually enter the telephone number via the keypad of the desk phone. This is tedious, particularly where long numbers or many numbers must be dialed, and can lead to dialing errors. Due to the inconvenience of this procedure, the user is likely to make calls from the mobile device rather than the fixed line telephone, typically incurring greater expense.

### SUMMARY OF THE INVENTION

According to one embodiment, there is provided a communication method including storing data defining a plurality of contacts in a memory of a first communication device. Selection of a contact, via a user interface of the first communication device, is detected. Communications are initiated with a second communication device to transfer data corresponding to the selected contact to the second communication device and to instruct the second communication device to initiate a call to a communication device of the selected contact

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a schematic diagram illustrating a system for automated transfer of numbers from a mobile communication device to a fixed line communication device according to one example of the present invention;

FIG. 2 is a schematic block diagram illustrating the functional components of the system of FIG. 1; and

FIG. 3 is a flow diagram illustrating the operation of the method and system of FIGS. 1 and 2.

### DETAILED DESCRIPTION

A method and system for automated number transfer from a mobile to a fixed telephone are described. In the following description, for purposes of explanation, numerous specific details are set forth in order to provide a thorough understanding of the present invention. It will be evident, however, to one skilled in the art that the present invention may be practiced without these specific details.

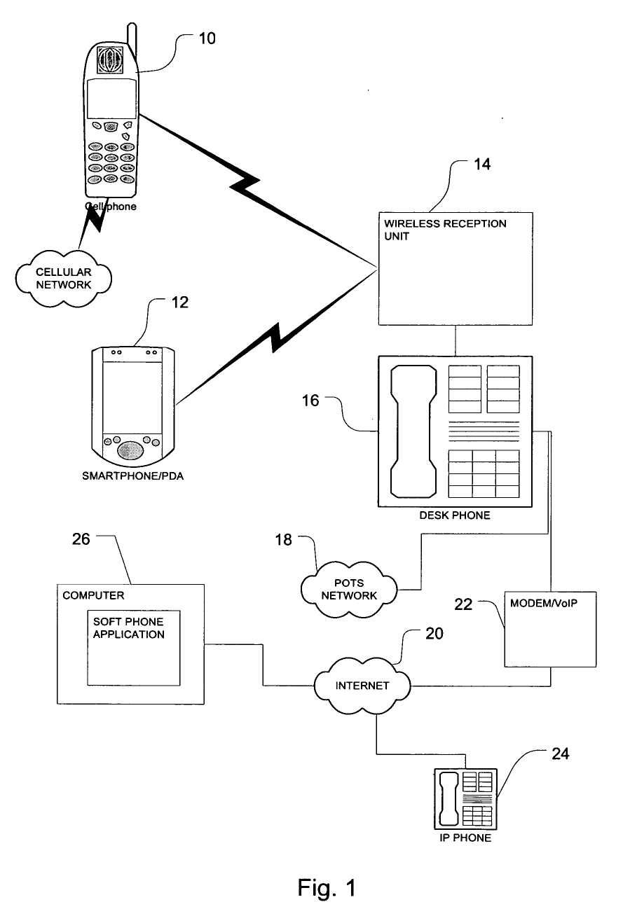

FIG. 1 shows the main components of an example system according to the present invention. The system includes a first communication device, which may be, for example, a mobile cellular telephone 10, or a personal digital assistant (PDA) or smart phone 12. Generally, the first communication device 10; 12 will be a portable, wireless device. The portable device 10; 12 is typically carried by a user of the system and stores contact data defining a plurality of contacts of the user.

Typically, the contact data stored in the portable device 10; 12 will include the name (whether partial or complete) of a person, company or other entity, and at least one telephone number, e-mail address or other contact details corresponding to the name. When the user wishes to make a call using the portable device, he or she selects a contact and initiates a call via a user interface of the portable device, typically a keypad or touch sensitive screen of the device.

For various reasons, it may be desirable to make a telephone call (or to send an e-mail or another communication) from a second, different communication device instead of the portable device. Generally, the second communication device will be a non-portable, wired or fixed line device. The second communication device could be a fixed line office telephone on the user's desk, a hotel telephone, a public telephone, for example. It may be that the reception via the portable device is not good in a particular area, or the user may wish to have the call billed to a different account than the account of the portable device. It may also simply be that a call made from the fixed line telephone will be cheaper than one made from the portable device.

The system includes a wireless reception unit 14 which can be connected to a conventional fixed line telephone 16. The telephone 16 can be connected to a conventional POTS telephone network 18, or to the Internet 20 via a modem 22 for Voice over IP (VoIP) communication with a compatible IP telephone 24, or to a computer 26 running a “soft phone” application.

It will be appreciated by those skilled in the art that instead of a fixed line telephone 16, another communication device such as a computer configured to communicate via the Internet or another network could be provided with the wireless reception unit 14.

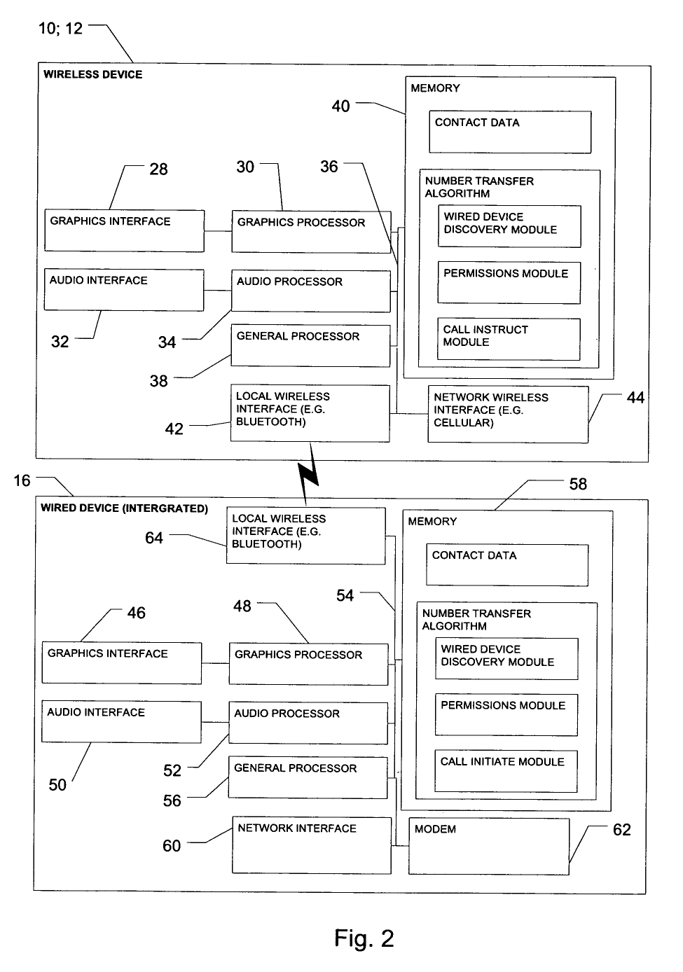

Referring now to FIG. 2, the functional components of the wireless portable communication device 10; 12 and the wired or fixed line communication device 16 are shown in greater detail. The mobile telephone 10 or PDA/Smartphone 12 each have a display or graphics interface 28 drive by a graphics processor 30, and an audio interface 32 in the form of a loudspeaker or earpiece driven by an audio processor 34. The processors 30 and 34 are connected via a bus 36 to a general processor 38 and to memory 40, as well as to a local wireless interface 42 and a network wireless interface 44 which will typically be a radio transceiver designed to operate as part of a cellular telephone network.

The wired communication device 16, typically a conventional fixed line desk telephone, has a display or graphics interface 46 driven by a graphics processor 48, as well as an audio interface 50 typically comprising a handset and a hands-free loudspeaker, driven by an audio processor 52. The processors 48 and 42 are linked via a bus 54 to a general processor 56. The bus also links the processors to memory 58, a network interface such as a conventional POTS line interface 60, an optional voice-over IP (VOIP) modem 62, and a local wireless interface 64 compatible with the local wireless interface 42 of the wireless device 10; 12.

The memory 40 of the portable device 10; 12 stores contact data entered by a user of the device and a number transfer algorithm in the form of software which may have been preinstalled on the device or which may have been uploaded to the device via one of the interfaces 42 or 44, or via another interface (not shown) such as a serial interface connectable to a complementary interface of a personal computer.

A portion of the memory 58 of the wired device 16 is designated for contact data transferred from the wireless device, and also contains a number transfer algorithm which interacts with the number transfer algorithm of the portable device in use.

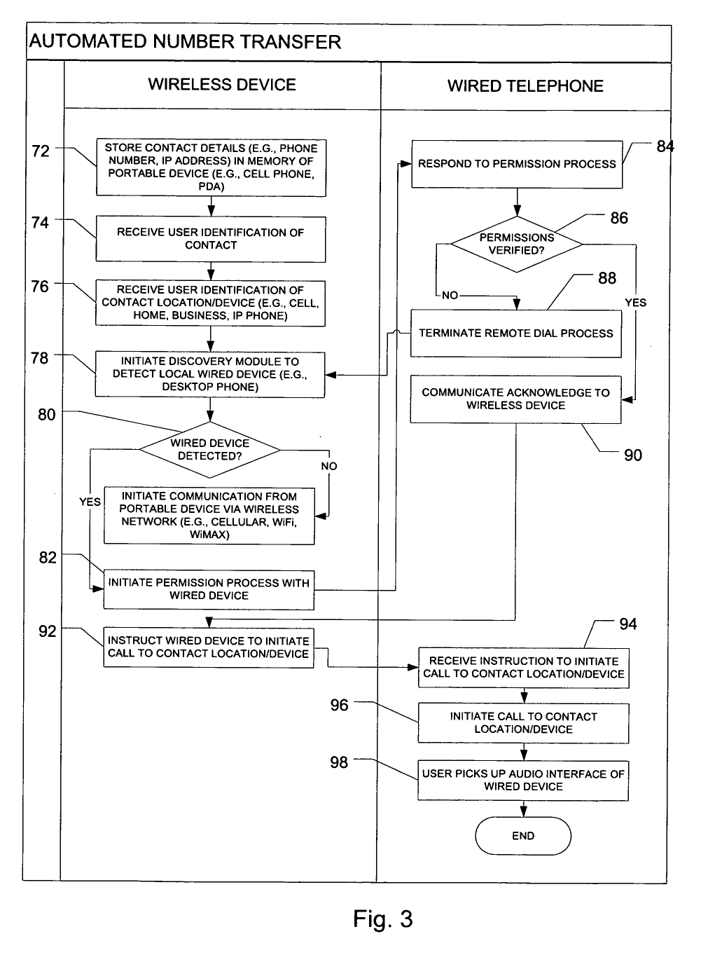

The operation of the system is described with reference to the flowchart of FIG. 3.

A user of the portable device 10; 12 stores (block 72) contact data in the memory 40 of the portable device for later use. When the user wishes to initiate a call using the method and system of one example embodiment of the present invention, the user operates the portable device to identify (block 74) a desired contact and, if the selected contact has more than one contact option, selects (block 76) the relevant option according to the desired location or device of the contact. For example, the contact may have a mobile telephone number, a home telephone number, a business telephone number and an IP phone number stored under the relevant contact heading, one of which can be selected by the user.

The user now initiates (block 78) a wired device discovery module of the number transfer algorithm in the portable device to detect a compatible communication device with which it can pair. The portable device transmits polling signals via the local wireless interface 42 to any third party devices within range. If a suitable device is detected (block 80), a permission module in the portable device is then activated (block 82) which communicates with the wired device 16 via its local wireless interface 64.

The permission process may operate to verify at least one of an identity and permission status. For example, the identity of the caller may be determined from the information stored on a SIM card of the wireless device 10. The wired device 16 may, in one embodiment, store (or have access to) a list of authorized users whose mobile telephones may be paired with the desk phone 16, via the wireless reception unit 14, the permissions module thus having access to this information. The wired device 16 may further be coupled to a database in which such a list of authorized users is maintained. In one embodiment, the wired device 16 may also have access to financial information regarding a user of the wireless device 10, so as to enable the wired device 16 to check debit or credit information pertinent to the permissions process. For example, the system may operate under any “prepaid” model, where a user is required to have prepaid for calls made via the wired device 16, prior to allowing a transfer of a telephone number from the wireless device 10 to the wired device 16.

The permission module in the memory 58 of the wired device 16 verifies (blocks 84-88) whether or not the portable device is authorized to initiate a call remotely and, if so, communicates (block 90) an acknowledgement to the portable device. A call initiate module of the portable device then runs and transmits (block 92) an instruction to the wired device to initiate a call to the selected contact. When the instruction is received (block 94), the contact data is used by the call initiate module in the memory 58 of the wired device 16 to initiate (block 96) a call to the selected contact via the network interface 60 or the modem 62 of the wired device, and the user then receives (block 98) the call via the audio interface of the wired device 16. The call can be terminated in a conventional manner (block 100).

Typically, a user of suitable portable wireless and fixed line or wired devices will need to pair them once, after which they can connect, carry out the permission process and initiate calls in a manner transparent to the user.

Although an example has been described involving mobile and fixed line telephones, it will be appreciated that variations involving, for example, the sending of an e-mail from a portable PDA to a personal computer fitted with a wireless reception unit 14, or other variations, are possible.

The wireless reception unit 14 can be built into a conventional telephone, personal computer or other communication device, or could be provided as a separate plug-in module. Optionally, the wireless reception unit comprises a Bluetooth (trade mark) transceiver able to receive data from and send data to the standard Bluetooth interface now built into many portable telephones and similar devices.

Thus, a method and system to facilitate the making of telephone calls or other communications via a fixed line telephone, using contact data from a portable telephone or other portable communication device, have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A communication method including:
storing data defining a plurality of contacts in a memory of a first communication device;
detecting selection of a contact via a user interface of the first communication device; and
communicating with a second communication device to transfer data corresponding to the selected contact to the second communication device and to instruct the second communication device to initiate a call to a communication device of the selected contact.

2. A method according to claim 1, including:
identifying the second communication device with which the first communication device is able to establish a connection; and
communicating with the second communication device to initiate a permission process between the first communication device and the second communication device, the permission process to verify at least one of an identity and permission status of the first communication device prior to initiating the call.

3. A method according to claim 1, including instructing the second communication device to initiate a call to a communication device of the selected contact via a fixed line telephone network.

3. A communication system including:
a first communication device having a memory to store data defining a plurality of contacts, a user interface operable to select a desired contact, and a first communication interface; and
a second communication device comprising a second communication interface to receive data from the first communication interface of the first communication device and a network interface to communicate with a third party communication device via a network;
wherein the first communication device is to transmit contact data to the second communication device corresponding to a selected contact and to transmit instruction data to instruct the second communication device to initiate a call, the second communication device being responsive to the instruction data to initiate a call to a communication device of the selected contact.

4. A system according to claim 3, wherein the first communication device is a portable wireless communication device.

5. A system according to claim 4, wherein the first communication device is a mobile telephone.

6. A system according to claim 4, wherein the first communication device is a PDA.

7. A system according to claim 3, wherein the second communication device includes a fixed line communication device.

8. A system according to claim 7, wherein the second communication device includes a conventional fixed line telephone.

9. A system according to claim 3, wherein the second communication interface of the second communication device includes a local wireless interface to receive data from and to transmit data to the first communication interface of the first communication device.

10. A system according to claim 9, wherein the local wireless interface of the second communication device is a Bluetooth interface.

11. A communication device including:
a user interface;
a network interface to communicate with a third party communication device via a network;
a communication interface to receive contact data and instruction data from a third party communication device having a complementary communication interface; and
a processor responsive to the instruction data to initiate a call via the network interface to a third party communication device identified by the contact data.

12. A device according to claim 11, wherein the third party communication device having a complementary communication interface is a portable wireless communication device.

13. A device according to claim 12, wherein the portable wireless communication device is a mobile telephone.

14. A device according to claim 12, wherein the portable wireless communication device is a PDA.

15. A device according to claim 11, wherein the network interface is a fixed line interface to a conventional telephone network.

16. A device according to claim 11, wherein the communication interface includes a local wireless interface to receive data from and to transmit data to the third party communication device having a complementary communication interface.

17. A device according to claim 16, wherein the local wireless interface is a Bluetooth interface.
